(19) United States
(12) Patent Application Publication
(10) Pub. No.: US 2024/0160859 A1
(43) Pub. Date: May 16, 2024

(54) MULTI-MODALITY SYSTEM FOR RECOMMENDING MULTIPLE ITEMS USING INTERACTION AND METHOD OF OPERATING THE SAME

(71) Applicant: ELECTRONICS AND TELECOMMUNICATIONS RESEARCH INSTITUTE, Daejeon (KR)

(72) Inventors: Eui Sok CHUNG, Daejeon (KR); Hyun Woo KIM, Daejeon (KR); Jeon Gue PARK, Daejeon (KR); Hwa Jeon SONG, Daejeon (KR); Jeong Min YANG, Daejeon (KR); Byung Hyun YOO, Daejeon (KR); Ran HAN, Daejeon (KR)

(73) Assignee: ELECTRONICS AND TELECOMMUNICATIONS RESEARCH INSTITUTE, Daejeon (KR)

(21) Appl. No.: 18/507,953

(22) Filed: Nov. 13, 2023

(30) Foreign Application Priority Data
Nov. 14, 2022 (KR) 10-2022-0152017
Jul. 31, 2023 (KR) 10-2023-0099695

(51) Int. Cl. G06F 40/40

(52) U.S. Cl. CPC G06F 40/40

(57) ABSTRACT

The present invention relates to a multi-modality system for recommending multiple items using an interaction and a method of operating the same. The multi-modality system includes an interaction data preprocessing module that preprocesses an interaction data set and converts the preprocessed interaction data set into interaction training data; an item data preprocessing module that preprocesses item information data and converts the preprocessed item information data into item training data; and a learning module that includes a neural network model that is trained using the interaction training data and the item training data and outputs a result including a set of recommended items using a conversation context with a user as input.

### CROSS-REFERENCE TO RELATED APPLICATION

This application claims priority to and the benefit of Korean Patent Application No. 10-2022-0152017, filed on Nov. 14, 2022 and Korean Patent Application No. 10-2023-0099695, filed on Jul. 31, 2023, which are hereby incorporated by reference for all purposes as if set forth herein.

### BACKGROUND

### 1. Field of the Invention

The present invention relates to a multi-modality system for recommending multiple items using an interaction with a user and a method of operating the same.

### 2. Discussion of Related Art

User answer processing through an interaction is generally performed in the form of a conversation with a user using a natural language processing technology and an artificial intelligence technology, and a pre-trained conversation model is used to generate appropriate answers to user's questions or requests.

That is, in order to perform the interaction processing, it should be possible to generate a “next utterance of a system” by inputting a “conversation history between a system and a user” that ends with a user query. In this regard, it cannot be easy to construct the corresponding interaction data depending on the field (area) in which the interaction processing is performed. That is, a language generation approach may not simply solve the above problem even if it uses a large-capacity pre-trained language model. However, when the system utterance is limited, it is possible to convert the corresponding type of system utterances into a cluster ID through clustering and convert the system utterance problem into a problem of predicting the corresponding cluster ID.

Meanwhile, a multi-modality technology is a technology that constructs an artificial intelligence model using various types of inputs and outputs. The type of inputs may be composed of various modes (modalities), and mainly uses text, images, voice, etc.

The multi-modality technology has recently been applied in various fields such as natural language processing, computer vision, and voice processing.

Meanwhile, the background art of the present invention is disclosed in Korean Patent Laid-Open Publication No. 10-2012-0120163 (Nov. 1, 2012).

### SUMMARY OF THE INVENTION

The present invention provides a multi-modality system for recommending multiple items using an interaction and a method of operating the same that is capable of recommending items by gradually identifying user requirements through the interaction and allowing a single item to recommend a set of multiple items based on multi-modality.

According to an embodiment, a multi-modality system for recommending multiple items using an interaction includes: an interaction data preprocessing module that preprocesses an interaction data set and converts the preprocessed interaction data set into interaction training data; an item data preprocessing module that preprocesses item information data and converts the preprocessed item information data into item training data; and a learning module that includes a neural network model that is trained using the interaction training data and the item training data and outputs a result including a set of recommended items using a conversation context with a user as input.

The neural network model may be a single neural network that processes the interaction training data and the item training data.

The neural network may be based on a transformer.

The interaction data preprocessing module may assign interaction state information to each utterance in the conversation context with the user, cluster only system utterance, and divide the system utterance into a plurality of answer sets.

The learning module may further output information on answer utterance of the system as the result.

The information on the answer utterance may include previous interaction state information of a current input sequence, interaction state information of an answer of the system to be currently predicted, and identification information of the answer set.

The learning module may further include a decoder for generating an answer sentence based on the identification information of the answer set.

The interaction data preprocessing module may concatenates similar sentences among the system utterances in the answer set into one sentence.

The item data preprocessing module may separate the item information data into text information data and non-text information data, convert the text information data into a text feature, and convert the non-text information data into a non-text feature.

The item data preprocessing module may perform filtering on the text information data, connect the filtered text information data to convert into one string sequence, and use a pre-trained language model to convert the string sequence into the text feature.

Each item included in the set of recommended items may be expressed as composite modality of a text feature and a non-text feature.

The method may further include an evaluation module that evaluates the set of recommended items, in which the evaluation module may be configured to calculate a confidence score for two inputs using the conversation context with the user and each item as input or two items included in one set of recommended items as input.

The evaluation module may be trained to classify the two inputs as true/false through a binary classifier, and the confidence score may be based on a logit value of the binary classifier.

According to another embodiment, a method of operating a multi-modality system for recommending multiple items using an interaction includes: preprocessing an interaction data set and converting the preprocessed interaction data set into interaction training data; preprocessing item information data and converting the preprocessed item information data into item training data; and training a neural network model that is trained using the interaction training data and the item training data and outputs a result including a set of recommended items using a conversation context with a user as input.

The preprocessing of the interaction data set and converting of the preprocessed interaction data set into the interaction training data may include: assigning interaction state information to each utterance in a conversation context with the user; and clustering only system utterance and dividing the system utterance into a plurality of answer sets.

The preprocessing of the item information data and converting of the preprocessed item information data into the item training data may include: separating the item information data into text information data and non-text information data; and converting the text information data into a text feature and converting the non-text information data into a non-text feature.

The method may further include: calculating a confidence score for two inputs using the conversation context with the user and each item as input or two items included in one set of recommended items as input; and evaluating the set of recommended items based on the calculated confidence score.

According to still another embodiment, a multi-modality system for recommending multiple items using an interaction includes: a user device that receives a conversation for item recommendation from a user; and an item recommendation system that configures the conversation input from the user device and an answer transmitted to the user device into a series of conversation contexts, inputs the conversation contexts to a pre-trained neural network model, and outputs a result including a set of recommended items.

The neural network model may be trained based on item training data by preprocessing the interaction data set and preprocessing interaction training data and item information data.

The item may be one of clothes, a movie, music, travel, or a book.

### BRIEF DESCRIPTION OF THE DRAWINGS

FIG. 1 is a block diagram illustrating a configuration of a multi-modality system for recommending multiple items using an interaction according to an embodiment of the present invention.

FIGS. 2A and 2B are exemplary diagrams for describing interaction with a user of the multi-modality system for recommending multiple items using an interaction according to the embodiment of the present invention.

FIG. 3 is an exemplary diagram for describing system architecture of the multi-modality system for recommending multiple items using an interaction according to the embodiment of the present invention.

FIG. 4 is an exemplary diagram for describing a conversation script for recommending a cloth set in the multi-modality system for recommending multiple items using an interaction according to the embodiment of the present invention.

FIG. 5 is a flowchart for describing a process of preprocessing an interaction data set and converting the preprocessed interaction data into training data in the multi-modality system for recommending multiple items using an interaction according to the embodiment of the present invention.

FIG. 6 is an exemplary diagram for describing feature description information for each type of cloth item in the multi-modality system for recommending multiple items using an interaction according to the embodiment of the present invention.

FIG. 7 is a flowchart for describing a process of preprocessing cloth information data to use the cloth information data as training data in the multi-modality system for recommending multiple items using an interaction according to the embodiment of the present invention.

FIG. 8 is an exemplary diagram for describing a model structure for selecting one correct sentence from a predicted system answer cluster with reference to FIG. 3.

FIG. 9 is a flowchart for describing an evaluation of recommendations in the multi-modality system for recommending multiple items using an interaction according to the embodiment of the present invention.

FIG. 10 is an exemplary diagram for describing a local evaluation set in the multi-modality system for recommending multiple items using an interaction according to the embodiment of the present invention.

FIG. 11 is an exemplary diagram for describing a neural network for evaluating recommendations of the multi-modality system for recommending multiple items using an interaction according to the embodiment of the present invention.

FIG. 12 is an exemplary diagram for describing an output of the multi-modality system for recommending multiple items using an interaction according to the embodiment of the present invention.

### DETAILED DESCRIPTION OF EXEMPLARY EMBODIMENTS

Hereinafter, a multi-modality system for recommending multiple items using an interaction and a method of operating the same according to embodiments of the present invention will be described with reference to the attached drawings. In this process, thicknesses of lines, sizes of components, and the like, illustrated in the accompanying drawings may be exaggerated for clearness of explanation and convenience. In addition, terms to be described below are defined in consideration of functions in the present disclosure and may be construed in different ways by the intention of users or practice. Therefore, these terms should be defined on the basis of the contents throughout the present specification.

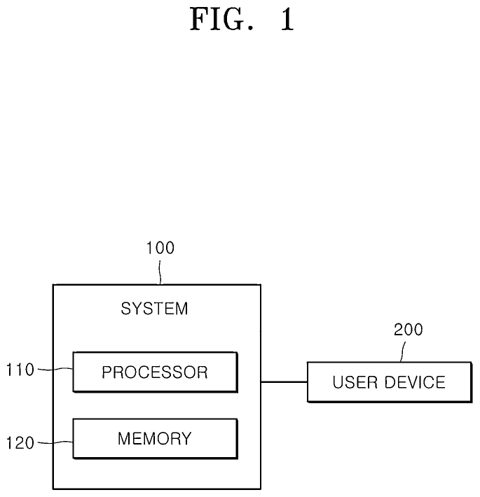

FIG. 1 is a block diagram illustrating a configuration of a multi-modality system for recommending multiple items using an interaction according to an embodiment of the present invention.

As illustrated in FIG. 1, a multi-modality system 100 for recommending multiple items may include a processor 110 and a memory 120, and perform an interaction with a user through data transmission and reception with a user device 200.

The processor 110 may implement operations and methods of a multi-modality system for recommending multiple items using an interaction, which will be described below. Instructions for implementing these operations and methods may be stored in the memory 120.

The processor 110 may include an application-specific integrated circuit (ASIC), other chipsets, logic circuits, and/or data processing devices. The memory 120 may include a read-only memory (ROM), a random access memory (RAM), a flash memory, a memory card, a storage medium, and/or other storage devices.

When the embodiment is implemented in software, the operation according to the present invention may be implemented as a module (process, function, and the like) for performing each function. The module may be stored in the memory 120 and executed by the processor 110. The memory 120 may be inside or outside the processor 110 and connected to the processor 110 by various means.

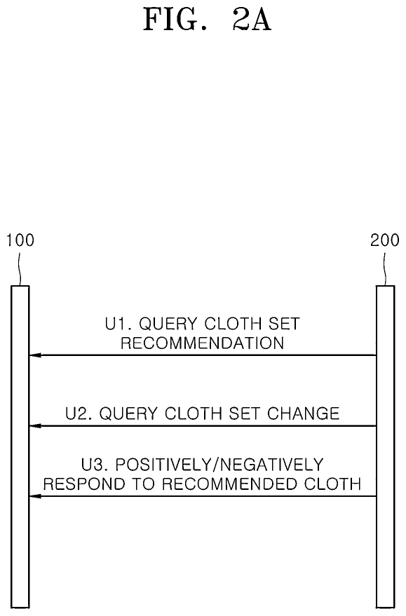

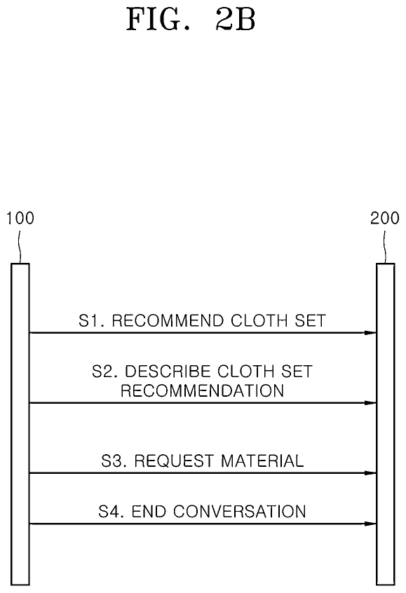

FIGS. 2A and 2B are exemplary diagrams for describing interactions with a user of the multi-modality system for recommending multiple items using an interaction according to the embodiment of the present invention.

As illustrated in FIGS. 2A and 2B, hereinafter, a system for recommending a cloth set will be described using an example. However, the technical scope of the present invention is not limited to the cloth set, and may be applied to other examples (movie recommendation, music recommendation, travel recommendation, and book recommendation) as will be described below.

FIGS. 2A and 2B illustrate an interaction state between the system 100 and the user (user terminal 200). Each interaction state is described independently, and U1 is a query requesting the user to recommend a cloth set considering his or her time, place, and occasion (TPO). U2 is a user's change request query to a cloth set recommended by the system. U3 is a user's answer to the cloth set recommended by the system. S1 is the cloth set recommended by the system that satisfies user requirements. S2 is an explanation of the intention of the system that recommends the cloth set as the cloth set recommended by the system. S3 serves to specify the user requirements by requesting additional inquiries from the user. S4 is an interaction end message. However, according to the embodiment, interaction states not presented in FIGS. 2A and 2B may be additionally considered.

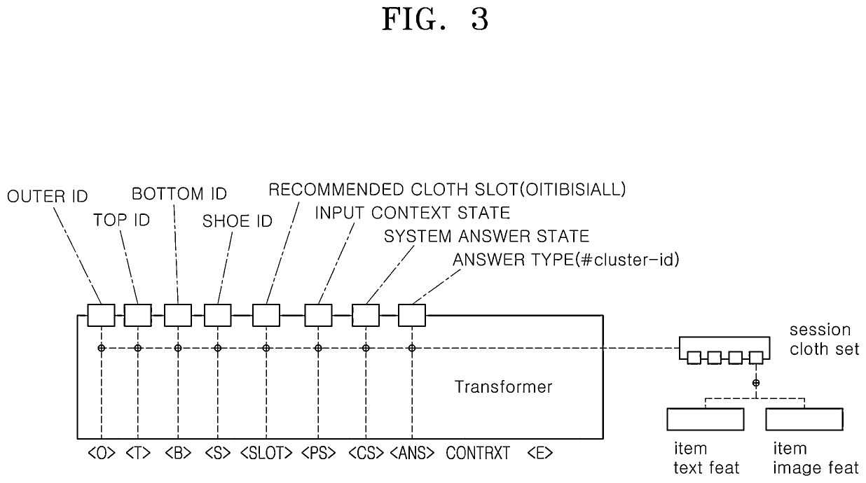

FIG. 3 is an exemplary diagram for describing system architecture of the multi-modality system for recommending multiple items using an interaction according to the embodiment of the present invention.

The multi-modality system for recommending multiple items using an interaction according to the embodiment of the present invention may use transformer-based pre-trained parameters. Since a transformer is a basic structure of the system architecture, cloth recommendation and answer generation are converted to suit the transformer structure. Here, a lower end portion of a transformer box may be called an input unit, and an upper end portion thereof may be called an output unit.

A “ <*>” form in the input unit is a special token, and may determine an output result type. <O> predicts “outer ID,” <T> predicts “top ID,” <B> predicts “bottom ID,” and <S> predicts “shoe ID.” <SLOT> predicts a combination of recommended cloth slots.

<PS> outputs a previous state of a current input sequence in the interaction state of FIGS. 2A and 2B, and <CS> outputs a system answer state that should currently be predicted. <ANS> generates an answer type.

Here, the answer type refers to a pre-prepared system answer type. This can be accessed through an answer set ID that may be obtained by extracting all system answer sentences from training data and clustering the system answer sentences. That is, the system's answer may be clustered into a plurality of answer sets, and cluster IDs of each set may indicate the answer type.

CONTEXT is a sequence of conversation sentences. Each conversation sentence may be mapped to a token ID, and thus, appear as a sequence of token IDs. <E> is a final termination symbol of the CONTEXT.

In FIGS. 2A and 2B, “session cloth set” represents a cloth set that is progressively recommended during the interaction. This may be composed of one or more cloth lists, and in the embodiment, {outer ID, top ID, bottom ID, shoe ID} are concatenated and described as one vector expression. The integration method may concatenate individual vectors representing cloth IDs and may then be described as a single vector representation through a fully-connected (FC) layer. The concatenated “session cloth set” vector sₜ may be coupled with the output unit of the system and used for prediction.

sₜ=FC([v_{t,O}, v_{t,T}, v_{t,B}, v_{t,S}])

One cloth item may be expressed as a composite modality of “item text feature” and “item image feature.” Concatenating the item text feature and the item image feature and converting the concatenated item text feature and item image feature into a cloth ID vector representation vₜ may be expressed as a gating gr-based weighted sum as follows. Here, sₜ₋₁ is the cloth ID of the previous operation, and W^{g} and b^{g} are learning parameters. The corresponding Equation is as follows.

vₜ=gₜ*vₜ^{txt}+(1−gₜ)*vₜ^{img}

gₜ=σ(sₜ₋₁·W^{g}+b^{g})

In a loss function for training a cloth recommendation model, if configured in the form of X=“conversation context,” Y=“session-cloth-set,” Z=(“cloth-set-recommendation” or “answer-type”), when T is training data, it may be represented as follows.

$$Loss = - {\sum }_{\{ X , Y , Z \} ∈ T} log p ( Z \vert X , Y )$$

Here, the “cloth-set-recommendation” has the output of “outer ID, top ID, bottom ID, shoe ID, and recommended cloth slot.” When expressing the recommended cloth slot as k={O, T, B, S, A }, if t=argmaxₜp(kₜ|X, Y), the loss function for the “cloth-set-recommendation” may be represented as follows.

$${Z}_{cloth - set - recommend} = \{ \begin{matrix}\begin{matrix}\begin{matrix}\begin{matrix}outer ID if k [ t ] = O \\ top ID if k [ t ] = T\end{matrix} \\ bottom ID if k [ t ] = B\end{matrix} \\ shoe ID if k [ t ] = S\end{matrix} \\ outer ID , top ID , bottom ID , shoe ID if k [ t ] = A\end{matrix}$$

$${Loss}_{cloth - set - recommend} = - log p ( {Z}_{cloth - set - recommend} \vert X , Y )$$

“answer-type” has an output of an “input context state, a system answer state, and an answer type (#cluster-id).” These are called S_{ctx}, Sᵣₑₛ, and A_{cluster-id} and the loss function for the “answer-type” may be represented as follows. Here, σ, β, and γ each are a real constant.

Loss_{answer-type}=−αlog p(S_{ctx}|X, Y)−Blog p(Sᵣₑₛ|X, Y)−γlog p(A_{cluster-id}|X, Y)

X=“Conversation context” is composed of the input of “<O> <> <B> <S> <SLOT> <PS> <CS> <ANS> CONTEXT <E>.” Y=“Session-cloth-set” becomes a vector St through the concatenation of features (qualities) of the cloth set.

As can be seen in FIG. 3, in the present embodiment, the system architecture is described through a transformer encoder format. In some embodiments, it is possible to convert the sentence corresponding to the “answer-type” part into the form directly generated by the system. In other words, it is sufficient to add a transformer decoder to the encoder model and proceed with training to generate an answer sentence corresponding to the “answer-type.”

As described above, the present embodiment describes the implementation of the system for cloth set recommendation in the form of a transformer-based pre-trained model. This method may be applied to other examples (movie recommendation, music recommendation, travel recommendation, and book recommendation) and may be expressed as follows.

TABLE 1

| Cloth Set | Movie | Music | Travel | Book |
|---|---|---|---|---|
| Recommendation | Recommendation | Recommendation | Recommendation | Recommendation |
| Clothes | Movie | Music | Travel | Book |
| Cloth set | Related Movie Set | Similar Movie Set | Travel Package | Related Book Set |
| | (Movies worth | (Music that is | | (Books worth |
| | watching | good to listen to | | reading based on |
| | together) | together) | | tastes |
| Clothes | Movie | Music | Tourist | Book Information |
| Information Text | Information Text | Information Text | Attractions, | Text |
| | | | Lodging, Restaurants, | |
| | | | Transportation | |
| | | | Information Text | |
| Clothes Image | Movie | Music Data | Related | Book Related |
| | Advertisement | | Image/Video | Sample |
| | Video | | Information | Illustration, Image |
| Cloth set | Movie | Music | Travel Package | Book |
| Recommendation | Recommendation | Recommendation | Recommendation | Recommendation |
| Query | Query | Query | Query | Query |

Therefore, the cloth set described in the present embodiment may be called a set of recommended items, each article of clothes may be called an individual item included in the set of recommended items, the cloth item text feature may be called an item text feature, and the cloth item image feature may be called an item non-text feature (e.g., image feature, audio feature).

In addition, the preprocessing of the interaction data set, which will be described below, may be performed by the interaction data preprocessing module, and the preprocessing of the item information data may be performed by the item data preprocessing module, and the transformer-based neural network model described above may be shown to be included in the learning module.

In this case, the transformer neural network model may be a neural network model that is trained using the interaction training data and the item training data, and outputs results including the set of recommended items and the information on the system's answer utterance using the conversation context with the user as input. The neural network model is composed of a single neural network, so the characteristics of the interaction and the item itself may be used together for item recommendation.

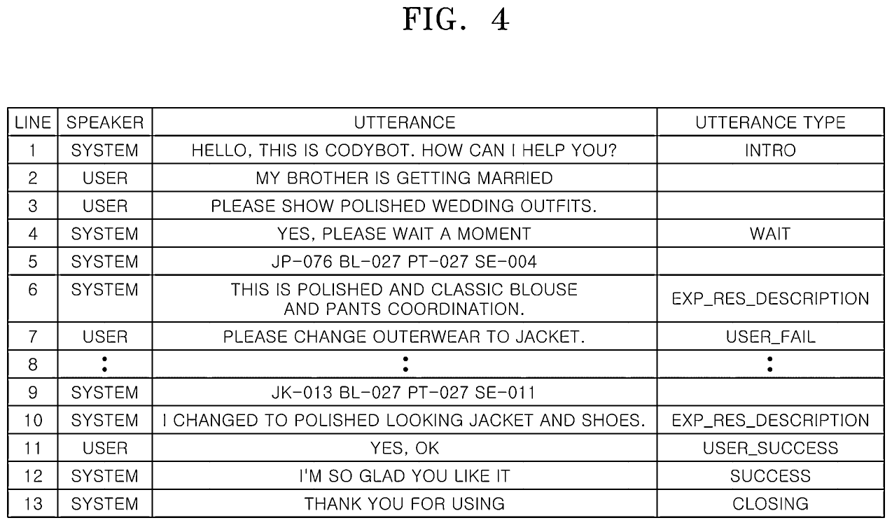

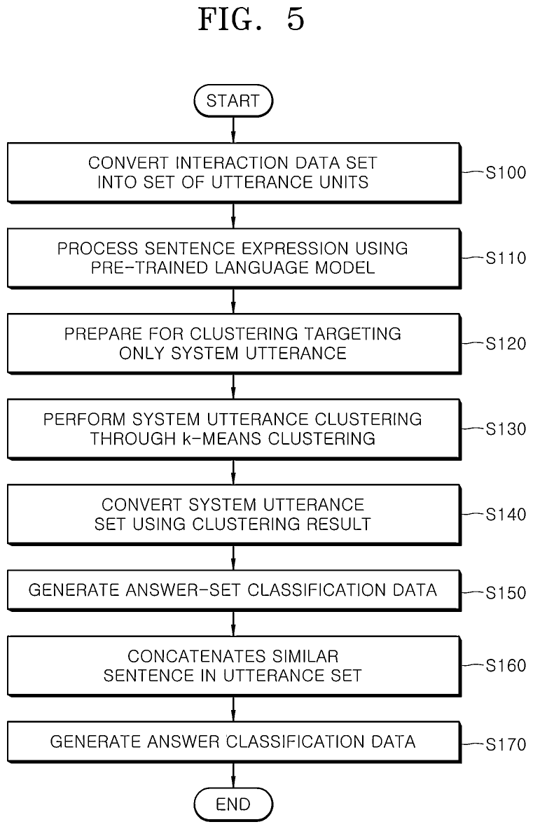

FIG. 4 is an exemplary diagram for describing a conversation script for recommending a cloth set in the multi-modality system for recommending multiple items using an interaction according to the embodiment of the present invention, and FIG. 5 is a flowchart for describing a process of preprocessing an interaction data set and converting the preprocessed interaction data into training data in the multi-modality system for recommending multiple items using an interaction according to the embodiment of the present invention.

In FIG. 4, a speaker is classified into a system and a user, and the system takes an approach of completing and recommending an appropriate cloth set according to user requirements. The interaction states of FIGS. 2A and 2B may be induced from the utterance type illustrated in FIG. 4.

First, the interaction data set is converted into a set of utterance units (S100). This converts each utterance of the conversation set in FIG. 4 into the form of (#id, sentence, interaction state).

Next, the sentence expression processing is performed using the pre-trained language model (S110). The sentence expression processing using the pre-trained language model performs sentence embedding through the transformer-based pre-trained language model such as bidirectional encoder representations from transformers (BERT). In this way, the sentence may be converted into the form of a sentence vector. However, since this sentence embedding may be performed through various methods already known in the technical field of the present invention, more detailed methods will not be described.

Thereafter, clustering is prepared for only the system utterance (S120). This prepares the input of the clustering module in the form of {(#id, sentence vector)}, targeting only the system utterance.

The clustering of the system utterance is performed through k-means clustering (S130). However, other clustering techniques according to the embodiment may be applied.

The system utterance set conversion is performed using the clustering result (S140). In other words, the system utterance clustered with a plurality of answer sets may be converted into the form of {(#id, #cluster-id)}.

Thereafter, answer-set classification data is generated (S150). When the system utterance is converted into the form of the answer type, the answer-set classification data is generated as {(conversation context, cloth-set, #cluster-id)}. Here, (input, output) may be (conversation context, cloth-set) or (conversation context and cloth-set, #cluster-id). The former is the cloth recommendation function, and the latter is training data for the answer generation function.

Thereafter, the specific configuration of the training data may be performed as follows.

First, similar sentences are concatenated in the utterance set (S160). The concatenation of the similar sentences in the utterance set concatenates sentences that are not differ significantly in meaning and have small lexical differences in a set of answer sentences and assigns a new sentence ID to the concatenated sentences so as to form {(#new-sent-id, #cluster-id)}.

The answer classification data is generated (S170). The answer classification data can generate positive samples {(conversation context, cloth-set, #cluster-id, #new-sent-id)} and one or more negative samples for each sample. The negative samples can be generated in real time in the training operation in the form of {(conversation context, cloth-set, #cluster-id, #new-sent-id')}. Here, #new-sent-id' becomes a negative sample of #new-sent-id.

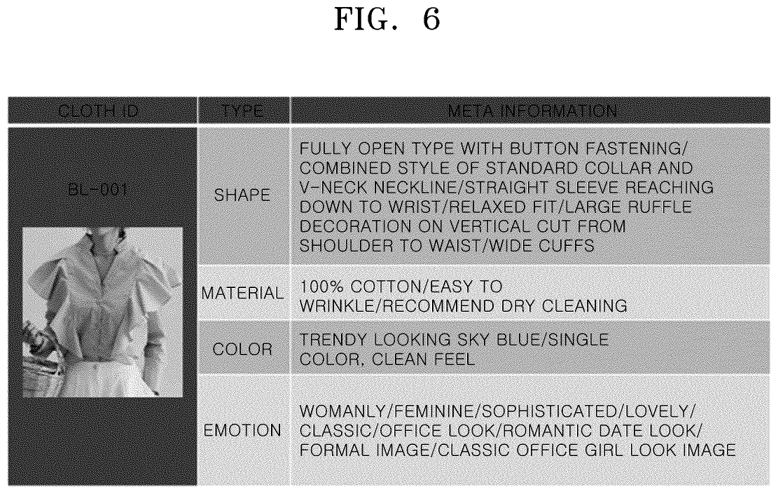

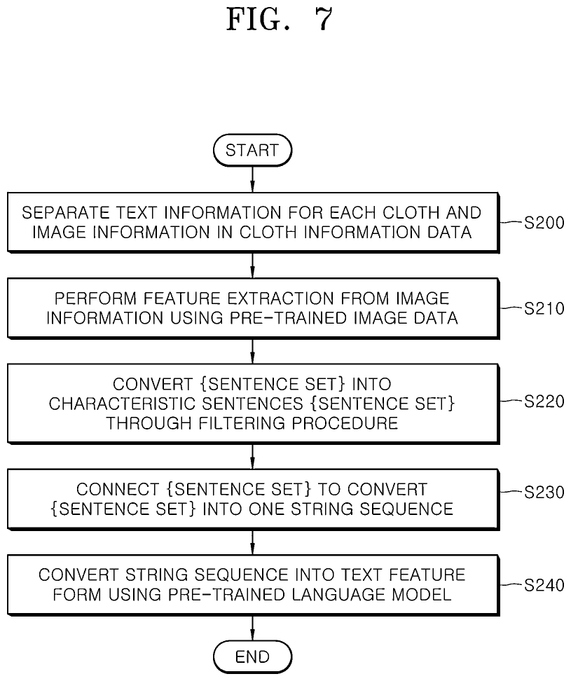

FIG. 6 is an exemplary diagram for describing feature description information for each type of cloth item in the multi-modality system for recommending multiple items using an interaction according to the embodiment of the present invention, and FIG. 7 is a flowchart for describing a process of preprocessing cloth information data to use the cloth information data as training data in the multi-modality system for recommending multiple items using an interaction according to the embodiment of the present invention.

FIG. 6 illustrates feature description information for each type of cloth ID BL-001. This expresses all information on the cloth item used in the present embodiment.

The image information may also be used, and the type is composed of a shape, a material, color, and emotion, but is not particularly limited thereto, and the characteristics of each type are described as sentences.

As illustrated in FIG. 7, the cloth information data may be preprocessed to be used as training data.

First, the text information and the image information for each cloth are separated from the cloth information data (S200). Next, features (quality, characteristics) are extracted from the image information using image pre-training data (S210). The {sentence set }, which is the text information, is converted into {sentence set }' representing characteristic sentences for each cloth through a filtering procedure (S220). That is, the cloth information data may be separated into the image information and the text information and extract their features, the image information may be processed through a pre-trained image-based feature extraction model or the like, and the text information may be filtered in advance to exclude unnecessary sentences. For example, the filtering may be performed by excluding sentences that do not include words that are preset as being related to the feature.

Thereafter, the {sentence set}' is concatenated and converted into a single string sequence (S230), and the string sequence is converted into the form of the text feature using the pre-trained learning model (S240). That is, the string sequence may be processed through a pre-trained text-based feature extraction model, etc.

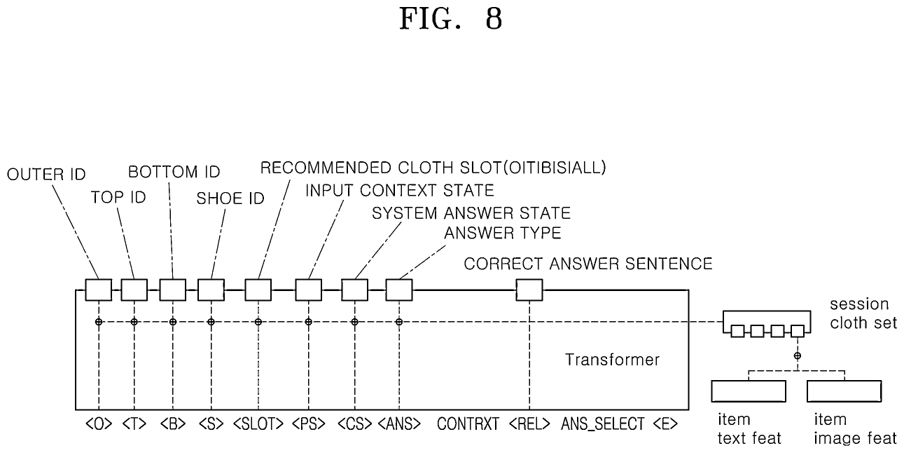

FIG. 8 is an exemplary diagram for describing a model structure for selecting one correct sentence from a predicted system answer cluster with reference to FIG. 3. Here, ANS_SELECT has the same structure as CONTEXT and serves as a system answer sentence candidate. <REL> is a special symbol, and may allow the corresponding output to train whether ANS_SELECT is a correct answer sentence or not through a binary classifier. In this way, it is possible to calculate the relatedness between ANS_SELECT, which is answer cluster composition sentences, and the context.

Here, when the ANS_SELECT is a positive sample, the binary classifier becomes true, and when the ANS-SELECT is a negative sample, the binary classifier becomes false. In this case, a logit value of D=<REL> may be used to determine the relatedness. The following is the loss function for training.

$${Loss}_{ans} = - {\sum }_{s ∈ POS} ( log p ( D = 1 \vert CONTEXT , s ) + {\sum }_{{s}^{′} ∈ NEF ( s )} log p ( D = 0 \vert CONTEXT , {s}^{′} ) )$$

After the training is completed, when relatedness (context, s) calculates the relatedness between the context and the answer sentence candidate s when the context and the answer sentence candidate s are input, the answer sentence may be determined as follows.

$${max}_{s ∈ \{ \# cluster \}} relatedness ( context , s )$$

That is, based on a classification probability value of the binary classifier, the answer sentence candidate with the highest probability value for the input context may be determined to be the answer sentence.

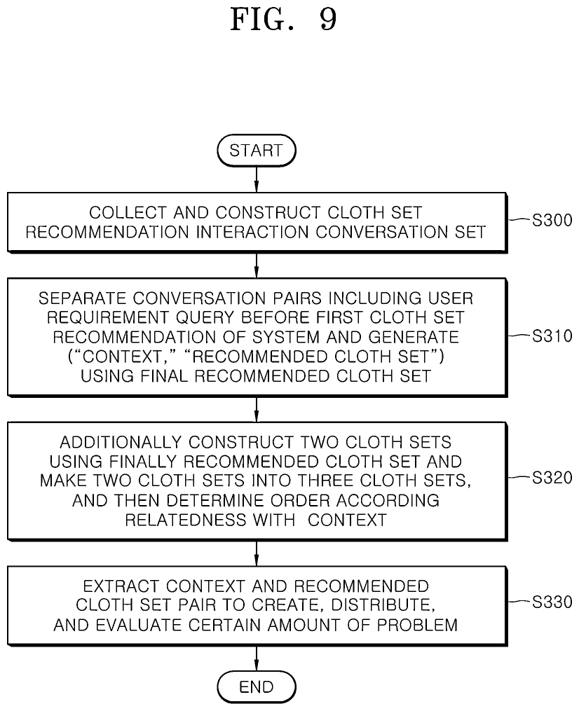

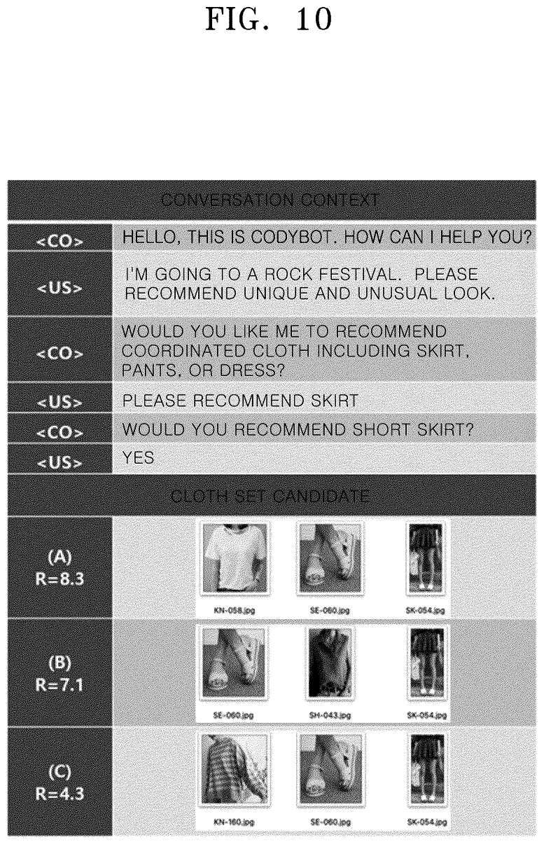

FIG. 9 is a flowchart for describing an evaluation of recommendations in the multi-modality system for recommending multiple items using an interaction according to the embodiment of the present invention, and FIG. 10 is an exemplary diagram for describing a local evaluation set in the multi-modality system for recommending multiple items using an interaction according to the embodiment of the present invention.

Referring to FIG. 8, the multi-modality system for recommending multiple items using an interaction according to the embodiment of the present invention provides cloth set recommendation and system answer prediction functions. Here, system answer prediction enables automatic system evaluation using a test set through an approach of predicting an answer cluster ID. However, in the case of the cloth set recommendation, there may be a variety of cloth sets suitable for the context, so an evaluation method thereof is required.

The present embodiment describes a method of performing automatic evaluation on cloth set recommendation through two cloth recommendation evaluation sets. However, the number of cloth recommendation evaluation sets may not be limited thereto.

As illustrated in FIG. 9, collection and construction of a cloth set recommended interaction dialogue set are performed (S300). That is, the construction of the conversation script in the form illustrated in FIG. 4 and feature information in the form illustrated in FIGS. 6 and 7 should be performed first.

Thereafter, conversation pairs including user requirement queries are separated until the system recommends a first cloth set, and (“context,” “recommended cloth set”) is generated using the final recommended cloth set (S310). That is, in the case of FIG. 3, the “context” is lines 1 to 3, and the “recommended cloth set” is line 9.

Using the final recommended cloth set, two additional cloth sets are constructed to make three cloth sets, and then the order is determined according to the relatedness with the context (S320).

For example, FIG. 10 illustrates an example of a local evaluation set generated. Evaluation may be performed by dividing the conversation context and each of the three cloth set candidates into three pairs, calculating the relatedness, determining a ranking order of the three pairs, and then calculating the correlation.

By extracting the context and the recommended cloth set pairs, a certain amount of problems are generated, distributed, and evaluated (S330).

This reflects the evaluation based on user feedback, distributes scales 0 to 10 according to the relatedness and acquires evaluation scores from a user (evaluator). This generates a global evaluation set. FIG. 10 illustrates scores of R=8.3, R=7.1, and R=4.3 assigned to cloth set candidates (A), (B), and (C), respectively. The evaluation is performed by assigning the cloth set candidates (A), (B), and (C) as an average relatedness score for various conversation contexts and cloth set candidates, and calculating the correlation with the system's evaluation of these scores.

The cloth set recommendation evaluation score may be calculated as α* correlation_{local}+(1−α)*correlation_{global}. Correlationlocal targets ranking for a single context and similar cloth sets, and correlationglobal evaluate a confidence score for heterogeneous contexts and cloth sets.

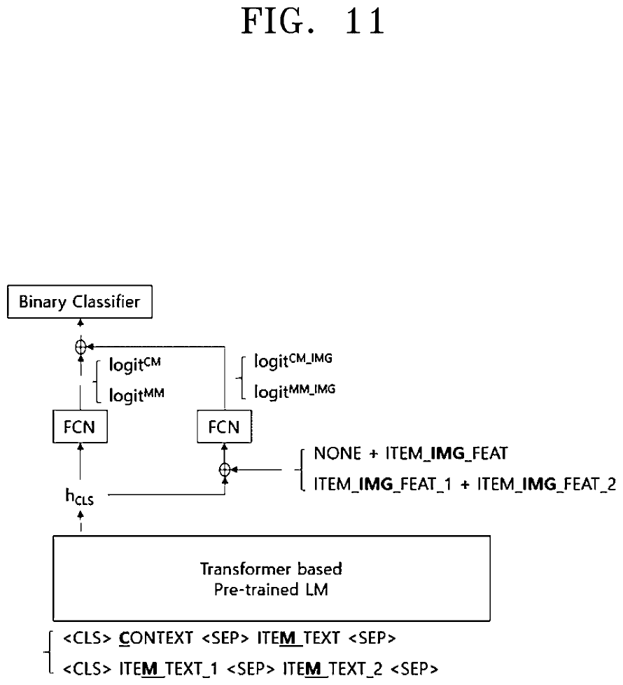

FIG. 11 is an exemplary diagram for describing a neural network for evaluating recommendations of the multi-modality system for recommending multiple items using an interaction according to the embodiment of the present invention.

In other words, as described above, the transformer-based pre-trained learning model is used. This network N uses (“context,” “recommended cloth set”) as input and calculates the confidence score therefor. This score may be viewed as the relatedness of the input pair. The specific method is as follows.

When the “recommended cloth set” is “cloth 1 30 cloth 2+. . . cloth n”, the confidence score may be calculated as N (“context,” “cloth 1”)+N (“context,” “cloth 2”)+. . . N (“context,” “cloth n”). Therefore, the input may be simplified to (“context,” “recommended cloth”). Furthermore, it may be further considered as a pair of two items constituting the “recommended cloth set” and added to the input. Therefore, the input of N has two types: (“context,” “recommended cloth”) and (“recommended cloth 1,” “recommended cloth 2”).

FIG. 10 illustrates two input sequences: “<CLS> CONTEXT <SEP>ITEM_TEXT <SEP>” and “<CLS> ITEM_TEXT_1 <SEP> ITEM_TEXT_2 <SEP>.” Here, <CLS> is a special symbol for calculating the logit value of the input sequence. <SEP> is a special symbol for separating input types. Each of the two inputs is concatenated with the image for multi-modality processing. Images are processed as “NONE+ITEM_IMG_FEAT” and “ITEM_IMG_FEAT_1+ITEM_IMG_FEAT_2.” The two sequences each pass through fully convolutional networks (FCN) and have logit values as true/false targets before inputting the binary classifier. The text and image logits are concatenated for input i in the following two types:

$${logit}_{i} = \{ \begin{matrix}{logit}_{i}^{CM} + β \times {logit}_{i}^{CM \_ IMG} or \\ {logit}_{i}^{MM} + β \times {logit}_{i}^{MM \_ IMG}\end{matrix}$$

Here, β becomes a weight of the image logit.

When the cloth set of the input recommended cloth set i is s(i) and all sets composed of a pair of the recommended cloth set i is sp(i), the score for the input may be obtained as follows.

$${score}_{i} = {\sum }_{j ∈ s ( i )} {logit}_{i , j}^{CM} + α \times {\sum }_{j ∈ sp ( i )} {logit}_{i , j}^{MM} + β \times {logit}_{i}^{IMG}$$

$${logit}_{i}^{IMG} = {\sum }_{j ∈ s ( i )} {logit}_{i , j}^{CM \_ IMG} + {\sum }_{j ∈ sp ( i )} {logit}_{i , j}^{MM \_ IMG}$$

The positive and negative data are generated from the training data and the network is trained so that the positive and negative data may be separated into the binary classifier.

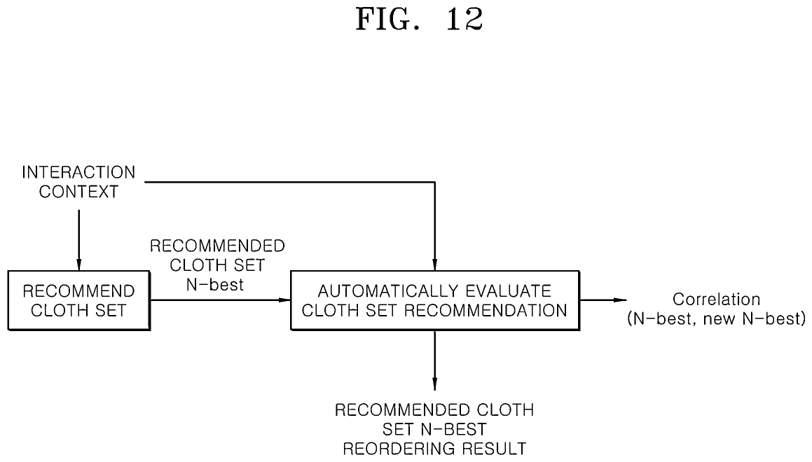

FIG. 12 is an exemplary diagram for describing an output of the multi-modality system for recommending multiple items using an interaction according to the embodiment of the present invention.

As illustrated in FIG. 12, the cloth set recommendation automatic evaluation module may be coupled with the cloth set recommendation module to provide two outputs. The cloth set recommendation module (the same architecture as illustrated in FIG. 3) may output the recommended cloth set based on the interaction context. In this case, the N-best cloth set may be output.

The cloth set recommendation automatic evaluation module (configuration in FIG. 11) may use the interaction context and the cloth set N-best generated by the cloth set recommendation module as input, and first output an N-best reordering result of the recommended cloth set. The cloth set recommendation automatic evaluation module may calculate the confidence score for the context and cloth set as described above. By reordering and outputting the N-best results using the same, it is possible to further improve the cloth set recommendation performance.

In addition, the cloth set recommendation automatic evaluation module may perform automatic evaluation on the cloth set recommendation module by a method of calculating the correlation between the N-best output of the cloth set recommendation module and the reordered N-best output of the cloth set recommendation automatic evaluation module.

According to a multi-modality system for recommending multiple items using an interaction and a method of operating the same according to the present invention, by implementing a neural network model based on interaction training data and item training data, it is possible to recommend a set of items using both the interaction and characteristics of the items themselves.

According to a multi-modality system for recommending multiple items using an interaction and a method of operating the same according to the present invention, it is possible to generate and present an answer to a user's question during the item recommendation in relation to the interaction.

According to a multi-modality system for recommending multiple items using an interaction and a method of operating the same according to the present invention, it is possible to evaluate a recommendation of a set of items through a reliability-based calculation.

Although the present invention has been described with reference to embodiments shown in the accompanying drawings, it is only exemplary. It will be understood by those skilled in the art that various modifications and equivalent other exemplary embodiments are possible from the present invention. Accordingly, a true technical scope of the present invention is to be determined by the spirit of the appended claims.

What is claimed is:

1. A multi-modality system for recommending multiple items using an interaction, comprising:
an interaction data preprocessing module that preprocesses an interaction data set and converts the preprocessed interaction data set into interaction training data;
an item data preprocessing module that preprocesses item information data and converts the preprocessed item information data into item training data; and
a learning module that includes a neural network model that is trained using the interaction training data and the item training data and outputs a result including a set of recommended items using a conversation context with a user as input.

2. The multi-modality system of claim 1, wherein the neural network model is a single neural network that processes the interaction training data and the item training data.

3. The multi-modality system of claim 2, wherein the neural network is based on a transformer.

4. The multi-modality system of claim 1, wherein the interaction data preprocessing module assigns interaction state information to each utterance in the conversation context with the user, clusters only system utterance, and divides the system utterance into a plurality of answer sets.

5. The multi-modality system of claim 4, wherein the learning module further outputs information on answer utterance of the system as the result.

6. The multi-modality system of claim 5, wherein the information on the answer utterance includes previous interaction state information of a current input sequence, interaction state information of an answer of the system to be currently predicted, and identification information of the answer set.

7. The multi-modality system of claim 6, wherein the learning module further includes a decoder for generating an answer sentence based on the identification information of the answer set.

8. The multi-modality system of claim 4, wherein the interaction data preprocessing module concatenates similar sentences among the system utterances in the answer set into one sentence.

9. The multi-modality system of claim 1, wherein the item data preprocessing module separates the item information data into text information data and non-text information data, converts the text information data into a text feature, and converts the non-text information data into a non-text feature.

10. The method of claim 6, wherein the item data preprocessing module performs filtering on the text information data, connects the filtered text information data to convert into one string sequence, and uses a pre-trained language model to convert the string sequence into the text feature.

11. The method of claim 7, wherein each item included in the set of recommended items is expressed as composite modality of a text feature and a non-text feature.

12. The method of claim 1, further comprising an evaluation module that evaluates the set of recommended items, wherein the evaluation module is configured to calculate a confidence score for two inputs using the conversation context with the user and each item as input or two items included in one set of recommended items as input.

13. The method of claim 12, wherein the evaluation module is trained to classify the two inputs as true/false through a binary classifier, and the confidence score is based on a logit value of the binary classifier.

14. A method of operating a multi-modality system for recommending multiple items using an interaction, comprising:
preprocessing an interaction data set and converting the preprocessed interaction data set into interaction training data;
preprocessing item information data and converting the preprocessed item information data into item training data; and
training a neural network model that is trained using the interaction training data and the item training data and outputs a result including a set of recommended items using a conversation context with a user as input.

15. The method of claim 14, wherein the preprocessing of the interaction data set and converting of the preprocessed interaction data set into the interaction training data includes:
assigning interaction state information to each utterance in a conversation context with the user; and
clustering only system utterance and dividing the system utterance into a plurality of answer sets.

16. The method of claim 14, wherein the preprocessing of the item information data and converting of the preprocessed item information data into the item training data includes:
separating the item information data into text information data and non-text information data; and
converting the text information data into a text feature and converting the non-text information data into a non-text feature.

17. The method of claim 14, further comprising:
calculating a confidence score for two inputs using the conversation context with the user and each item as input or two items included in one set of recommended items as input; and
evaluating the set of recommended items based on the calculated confidence score.

18. A multi-modality system for recommending multiple items using an interaction, comprising:
a user device that receives a conversation for item recommendation from a user; and
an item recommendation system that configures the conversation input from the user device and an answer transmitted to the user device into a series of conversation contexts, inputs the conversation contexts to a pre-trained neural network model, and outputs a result including a set of recommended items.

19. The multi-modality system of claim 18, wherein the neural network model is trained based on item training data by preprocessing the interaction data set and preprocessing interaction training data and item information data.

20. The multi-modality system of claim 18, wherein the item is one of clothes, a movie, music, travel, or a book.
